(19) United States
(12) Patent Application Publication
(10) Pub. No.: US 2014/0324317 A1
(43) Pub. Date: Oct. 30, 2014

(54) DISPLAY DEVICE AND METHOD FOR PRESENTING VEHICLE VARIABLES FOR A MOTOR VEHICLE

(71) Applicants: Heiko SCHILLING, Stuttgart (DE); Thomas Rauner, Blaubeuren (DE)

(72) Inventors: Heiko SCHILLING, Stuttgart (DE); Thomas Rauner, Blaubeuren (DE)

(73) Assignee: Dr. Ing. h.c. F. Porsche Aktiengesellschaft, Sttugart (DE)

(21) Appl. No.: 13/869,320

(22) Filed: Apr. 24, 2013

(51) Int. Cl. B60K 37/02

(52) U.S. Cl. CPC B60K 37/02
USPC 701/99; 701/1

(57) ABSTRACT

A display device for presenting vehicle variables for a motor vehicle, wherein the display device has a display unit for displaying the vehicle variables, a first selection module for selecting vehicle variables to be displayed and at least one interface to at least one vehicle device of the motor vehicle, wherein the selected vehicle variables to be displayed can be retrieved from the vehicle device via the interface and can be displayed on the display unit and a corresponding method.

### CROSS-REFERENCE TO RELATED APPLICATIONS

This application claims priority of German Patent Application No. 10 2012 103988.7, filed May 7, 2012, which is incorporated by reference herein in its entirety.

### FIELD OF INVENTION

The present invention relates to a display device for dynamically presenting vehicle variables for a motor vehicle. In addition, the present invention relates to an corresponding method.

### BACKGROUND

The prior art discloses the practice of using a display unit, particularly in a combination unit integrated in a dashboard or center console, to display to a driver of a motor vehicle various parameters, such as temperature, data, time, speed, tank fill, etc. This usually involves an onboard computer which can be used to request various items of information and parameters for the motor vehicle. The information is usually presented in said combination instrument using a separate screen in the center console or on the dashboard. By way of example, the displayable information on an onboard computer includes average consumption, servicing interval, oil level, temperature, tire pressure, battery check, current consumption, average speed, current speed, remaining range with an existing tank fill, exterior and interior temperature and also date and time.

EP 2 157 003 A1 discloses an evaluation device for ascertaining a CO₂ emission from a vehicle. The evaluation device described therein comprises at least one interface to a sensor for monitoring at least one vehicle device and a computation unit for determining a CO₂ emission from the vehicle on the basis of a detected state of the vehicle device monitored by means of the sensor. In addition, a further interface is used to transmit the determined CO₂ emission to an output unit.

DE 10 2008 041 255 A1 discloses a method which is used to inform a driver of a vehicle, particularly a motor vehicle, about his driving behavior by comparing a parameter which corresponds to a current driving behavior with an associated reference value. A piece of result information ascertained from this comparison is output and displayed.

### SUMMARY

It is now an object of the present invention to provide a way of providing an extended display concept which is used to provide a driver of a motor vehicle with the most comprehensive possible information about various vehicle variables and allows him to use an appropriate evaluation to draw conclusions about his driving behavior, for example.

Against the background of the prior art, the invention provides a display device for presenting a plurality of vehicle variables for a motor vehicle, wherein the display device has a display unit for displaying the vehicle variables, a first selection module for selecting vehicle variables to be displayed, a computation unit for ascertaining the vehicle variables to be displayed and at least one interface to at least one vehicle device in the motor vehicle, wherein data for ascertaining the selected vehicle variables to be displayed can be retrieved from the at least one vehicle device via the interface, the selected vehicle variables can be ascertained by means of the computation unit and can be displayed on the display unit, wherein the selected vehicle variables can be presented in relation to one another and/or to an operating state of the motor vehicle. The invention further provides a method for presenting vehicle variables for a motor vehicle, wherein a display device having a display unit for displaying the vehicle variables, a first selection module for selecting vehicle variables to be displayed, a computation unit for ascertaining the vehicle variables to be displayed and at least one interface to at least one vehicle device of the motor vehicle is provided, wherein data for ascertaining the selected vehicle variables to be displayed are retrieved from the vehicle device via the interface, the selected vehicle variables are ascertained by means of the computation unit and are displayed on the display unit, wherein the selected vehicle variables are presented in relation to one another and/or to an operating state of the motor vehicle. Further embodiments can be found in the description and claims that follow.

### DETAILED DESCRIPTION

The invention provides a display device for presenting a plurality of vehicle variables for a motor vehicle. The display device according to one aspect of the invention comprises a display unit for displaying the vehicle variables, a first selection module for selecting vehicle variables to be displayed, a computation unit for ascertaining the vehicle variables to be displayed and at least one interface to at least one vehicle device of the motor vehicle, wherein data for ascertaining the selected vehicle variables to be displayed can be retrieved from the at least one vehicle device via the interface, the selected vehicle variables to be displayed can be ascertained by means of the computation unit and can be displayed on the display unit. In this case, the selected vehicle variables to be displayed can be presented in relation to one another and/or to an operating state of the motor vehicle.

Usually, the vehicle variables to be displayed are presented both in relation to one another and in relation to a current, for example, operating state of the motor vehicle. Within the context of the present description, an operating state of the motor vehicle describes the manner in which the motor vehicle is operated. In this case, a current operating state is intended to describe how the motor vehicle is currently being operated, in which case a period of time can be prescribed which, on the basis of the current time, goes back for some time, such as 30 minutes, an hour or a driving cycle, etc., in order to be able to provide the driver with a statement regarding the vehicle variables over a particular time interval, distance interval or energy interval. The variable to be selected in this case (period of time, distance or energy span) can possibly be set by the driver himself. The driver is therefore able to obtain an overview of how his driving behavior influences respective vehicle variables over a particular period of time, a particular distance or an energy consumption. Alternatively, it can also be assumed that an operating state which is actually current is maintained by the driver for a prescribed time interval, which also allows statements about the behavior of respective vehicle variables.

In one refinement of the display device according to one aspect of the invention, the display device has at least one interface to at least one vehicle device, wherein the vehicle device is chosen from the group comprising engine controller, fuel sensor, charging and discharge sensor for monitoring a charging or discharge process for a storage battery device, distance sensor and/or time sensor. The various cited vehicle devices can be used to retrieve data for ascertaining various vehicle variables via the interface and to present the vehicle variables ascertained by this means in the display unit. A charging and discharge sensor can be used to monitor a charging or discharge process for a storage battery unit. A distance sensor and/or a time sensor can be used to evaluate ascertained further vehicle variables on the basis of time and/or on the basis of distance so as to be able to provide a driver with useful information.

In a further refinement, the selection of vehicle variables to be displayed can be made from a predefined and stored selection of vehicle variables. This means that particular vehicle variables, for example for configuring the vehicle software, are predefined and stored in the display device or in a memory unit connected thereto as vehicle variables to be displayed, which means that a driver is able to select from these stored vehicle variables those which he wishes to have displayed. Data relating to these selected vehicle variables are then retrieved via the respective interface to one or more appropriate vehicle devices of the motor vehicle, and the respective vehicle variables are then ascertained in the computation unit by means of the retrieved data and displayed in suitable fashion on the display unit.

In a further refinement of the display device according to one aspect of the invention, the display device has a second selection module which can be used to make a selection for forms or types of presentation. In this case, the selection of forms of presentation can be made from a predefined and stored selection of forms of presentation, this predefined and stored selection of forms of presentation comprising a bar chart, a pie chart and/or a temperature curve chart, for example. This means that the driver is able to select, among particular stored types of presentation, the form in which he wishes to have the vehicle variables that he has selected beforehand, and that are to be displayed, presented. Different charts can provide different information. In addition, different charts are more or less suited to different purposes and can be read more or less quickly, possibly even in a self-explanatory fashion. Since the driver usually has the information about the vehicle variables displayed by means of the display unit, and then wishes to read said information accordingly, during a trip in the motor vehicle, it is important that he is presented with the information that is displayed to him in as simple a form as possible and in a manner that is almost self-explanatory. Since a perception of information differs on an individual basis, the selection of the forms of presentation is important.

In a further refinement of the display device according to one aspect of the invention, the computation unit is also configured to evaluate vehicle variables to be displayed prior to corresponding display, in particular to compare them with respective appropriate reference values and/or to base them on a current operating state of the motor vehicle. The reference values may either be predefined and input model values which have been calculated beforehand and prescribed for the display device, or may be older ascertained, recorded and appropriately stored values. Both the reference values as model values and the older recorded and stored values may be stored in a memory unit of the display device itself or in a separate memory unit which is accessible to the display unit.

In this case, it is also conceivable for the computation unit to be configured to take a performed evaluation as a basis for creating and displaying or outputting to a driver respective learning curves for a driving behavior on the basis of various vehicle variables to be selected. This allows a driver to adapt his driving behavior such that the vehicle variables that he has selected, insofar as they can be manipulated by the driving behavior, can be optimized. Vehicle variables which can be influenced by a driving behavior, for example, are CO₂ emission or else other emissions which occur during operation of a motor vehicle.

In a further refinement of the display device according to one aspect of the invention, the display unit on the display device can be used to present a plurality of presentations for the vehicle variables to be displayed optionally simultaneously and/or in suitably overlapping fashion. This means firstly that it is possible for different vehicle variables, including from different trips, to be respectively displayed simultaneously on one and the same display unit, in different areas of the display unit, in a suitable form of presentation. Furthermore, however, it may also mean that forms of presentation of different vehicle variables to be displayed are displayed in such overlapping fashion that there is then a possibility for them to be compared. When a plurality of presentations of different vehicle variables to be displayed are overlapping, it is conceivable for an overall chart to be formed therefrom. Such an overall chart may be in a form such that a type of 3D graphic is displayed or else a 2D graphic having a plurality of different coordinate axes on which respectively different variables are plotted, for example. Further presentation options are conceivable in order to relate a plurality of vehicle variables to one another.

In a further refinement of the display device according to one aspect of the invention, a display of the vehicle variables to be displayed can be produced on the display unit in a tree structure, with dependencies of the vehicle variables being able to be mapped by the tree structure. In this case, the display of the tree structure can be optionally extended dynamically by means of appropriate activation. This means that the tree structure and the optionally extendable branching thereof allow vehicle variables that are to be displayed to be presented in finely structured form to a certain degree of detailing as a result of the branching or leaves of the tree structure.

In a further refinement of the display device according to one aspect of the invention, the display unit of the display device is configured to show comments or tips for a user of the display device, such as for a driver of the motor vehicle, in relation to vehicle variables displayed on the display unit automatically and/or upon request. In this case, the comments to be shown automatically and/or upon request can be retrieved from an expert system which is accessible to the display device. The comment or the expert system may in this case be stored on an external memory unit that is accessible to the display device, for example, or else may also be stored directly in a memory unit which is integrated in the display device.

The predefined and stored selection of vehicle variables comprises at least a CO₂ balance or CO₂ emission for the motor vehicle, particularly in an instantaneous operating state of the motor vehicle, a, by way of example, current zero emission proportion, respective proportions of various loads which are present in the motor vehicle, such as various propulsion units, like an internal combustion engine, E-motor, etc., in, by way of example, current propulsion for the motor vehicle, respective proportions of the various loads in respective, by way of example, current emissions from the motor vehicle, speeds travelled, average speed, etc. Some of these indicated vehicle variables are dependent on an operating state and can be related to current operating state when they are evaluated prior to display. Within the context of the present description, a current operating state is intended to be understood to mean an instantaneous driving state of the motor vehicle. This means that the current operating state indicates whether a vehicle is being driven and, if so, at what speed, for which environmental factors which propulsion units are involved in what form. As already explained above, a current operating state describes how the motor vehicle is operated over a given period of time. This means that this is intended to be assumed to be not a state at a specific time but rather a mode of operation over a prescribed period of time, which can possibly be specified by a user, or driving cycle. In this case, as likewise mentioned at the outset, it is either possible to specify a period of time looking back from an instantaneous time, such as 30 minutes or 60 minutes, for example, or alternatively it is possible to assume on the basis of the instantaneous time that the instantaneous operating state will be maintained for a particular period of time in the future. On the basis of this, a respective statement is made for the vehicle variables. Some of said vehicle variables are static, such as the various loads which are present in the motor vehicle. However, a dynamic aspect of the various loads which are present in the motor vehicle is in this case the fact of which of the loads are active in the current operating state of the vehicle, i.e. actively contribute to the operating state. Both static and dynamic factors i.e. factors which change on the basis of the respective operating states of the motor vehicle or on the basis of time, on the basis of distance or on the basis of energy, interact and are important as vehicle variables, particularly for evaluation and the process of relating them to one another, in order ultimately to obtain a statement about how an operating state of a motor vehicle can also be regarded in terms of a driving behaviour by a respective driver.

In a further refinement of the display device according to one aspect of the invention, the display unit of the display device can, as already mentioned, be used to produce a display of the vehicle variables to be displayed in a tree structure. In this case, dependencies of the vehicle variables can be mapped by the tree structure. This means that vehicle variables can be related to one another for a particular operating state, for example in the form of a pie chart, such as a respective proportion of respective loads in the propulsion of the motor vehicle. On the basis of this pie chart, it is conceivable for a further division to be made at the request of the driver, so that for each piece of pie a subordinate pie chart can be created which more closely characterizes the properties of the respective piece of pie again. This means that the display of the tree structure can be optionally extended dynamically by means of appropriate activation, for example by a driver of the motor vehicle. In this case, as one alternative, activation can be effected by touching a display presenting the vehicle variables on the display unit, with the driver touching the relevant piece of pie directly, for example, as mentioned above, for example, so that a further pie chart is displayed for this piece of pie. It is also conceivable for such activation to be effected by means of a gesture using gesture recognition that is stored in the display unit as appropriate.

On the basis of a further embodiment of the display device according to one aspect of the invention, the first selection module for selecting vehicle variables to be displayed is implemented on a display of the display unit in the form of a menu. This means that a user can use interactive user guidance with a graphical user interface to select which vehicle variables are intended to be displayed to him. In this case, the screen edge or window edge of the display unit may be provided with menu bars which summarize commands, for example under key terms or symbols. When one of these terms is selected, a list opens, that is to say, what is known as a drop-out menu with associated menu items which then in turn trigger commands. Alternatively, a bar containing icons may also be provided, said icons being able to be used for direct selection by clicking. Hybrid forms combining the aforementioned list, a drop-out menu and icons are also conceivable. Selection using a keyboard which is provided, which is coupled to the display unit, is conceivable, but not very useful in driving mode. Selection by means of icons can be effected using a touch screen or else by means of gesture recognition. Gesture recognition has the advantage that in this case the driving behaviour of the driver is adversely affected as little as possible.

In a further refinement of the display device according to one aspect of the invention, the second selection module for selecting a form of presentation for the selected vehicle variables and the vehicle variables to be displayed is also implemented interactively on the display unit. In this case too, the interaction with the user, particularly the driver, may be such that a gesture or touch on the surface of the display unit is sufficient for activation or selection.

The present invention according to one aspect also relates to a method for presenting vehicle variables for a motor vehicle, wherein a display device having a display unit for displaying the vehicle variables, a first selection module for selecting vehicle variables to be displayed, a computation unit for ascertaining the selected vehicle variables to be displayed and at least one interface to at least one vehicle device of the motor vehicle is provided, wherein data for ascertaining the selected vehicle variables to be displayed are retrieved from the vehicle device via the interface, the relevant vehicle variables are ascertained by means of the computation unit and are displayed on the display unit. In this case, the vehicle variables are presented in relation to one another and/or to an operating state of the motor vehicle.

In addition, the present invention relates to the use of a display device as described above and/or of a method according to the invention in a hybrid vehicle.

Further advantages and refinements of the invention can be found in the description and in the accompanying drawings.

It goes without saying that the features cited above and those yet to be explained below can be used not only in the respectively indicated combination but also in other combinations or on their own without departing from the scope of the present invention.

### BRIEF DESCRIPTION OF THE DRAWINGS

FIG. 1 shows a schematic illustration of a possible display of vehicle variables, as can be performed with an embodiment of the display device according to the invention.

FIG. 2 shows a schematic illustration of a further display or form of presentation, as can be performed in a further embodiment of a display device according to the invention.

FIG. 3 shows a schematic illustration of yet a further display as can be implemented with a further embodiment of a display device according to the invention.

FIG. 4 shows a schematic illustration of yet a further display as can be implemented with a further embodiment of a display device according to the invention.

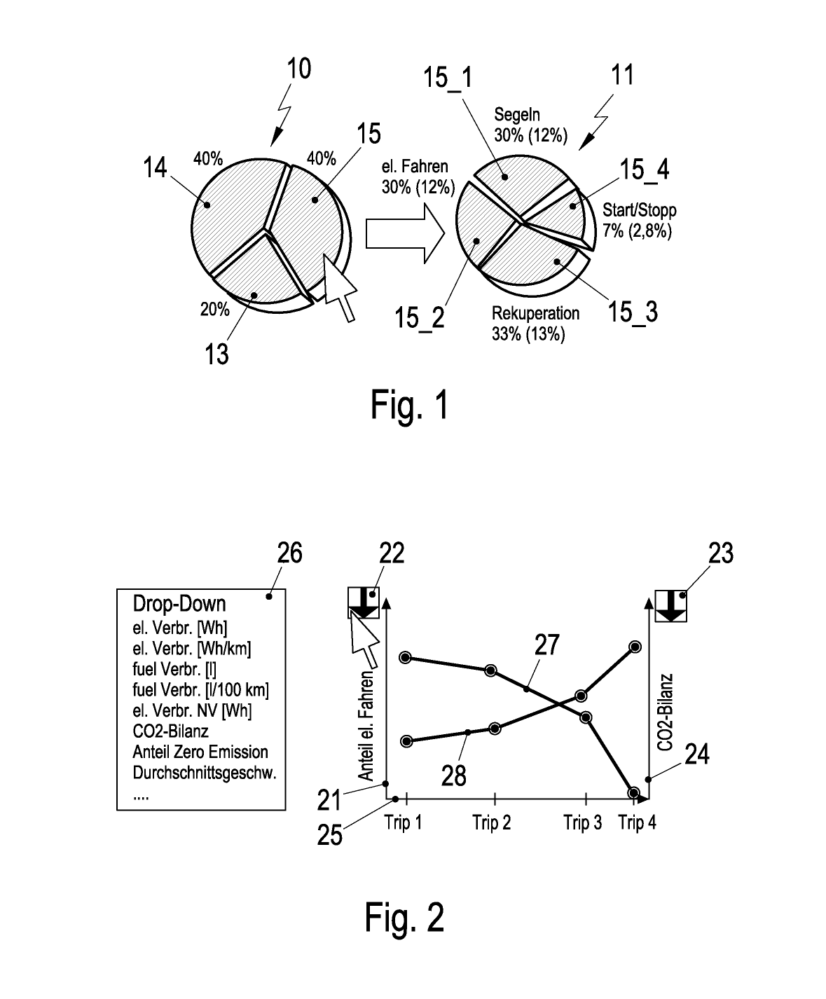

FIG. 1 shows a possible display of selected vehicle variables to be displayed on a display unit of a display device according to the invention. In this case, an evaluation of vehicle variables that have been ascertained and related to one another is presented in the form of two pie charts 10 and 11. The pie chart 10 shows how various propulsion units are proportionally involved in the propulsion in a current operating state of the motor vehicle. In this case, the propulsion units are a hybrid unit 13, an internal combustion engine 14 (ICE) and a zero emission proportion 15. The respective proportion of the various propulsion units is indicated as a percentage. A display of the display device displays the pie chart 10, which provides information about the nature of the distribution over the existing propulsion units in a current mode of operation of the motor vehicle. This means that for a particular driving behavior, i.e. in a current operating state of a motor vehicle, the type of propulsion of the motor vehicle is distributed over the various propulsion units which are present. In the example shown here, the motor vehicle can be propelled exclusively by an internal combustion engine 14 or by a hybrid propulsion system 13 or can be operated with zero emission 15. The example shown here shows a proportion of propulsion with just the internal combustion engine of 40%, propulsion with a hybrid propulsion system of 20%, and the zero emission proportion is likewise 40%, which makes up a total of 100% for the propulsion of the motor vehicle. At the request of the driver, it is now possible for one of the proportions, such as the zero emission proportion 15 in this case, to be once again broken down in a further pie chart 11 with respect to the respective different contributions to this zero emission proportion 15, i.e. the pie chart 11 shows the parts from which this proportion is made up. Assuming that the zero emission proportion 15 is set to 100%, the relative proportion of coasting is 30%, that of a starting/stopping mechanism, for example at traffic lights, is 7%, that of recuperation, i.e. recuperation of energy, is 33%, and that of pure electric driving is 30%. The respective absolute proportions based on all of the propulsion including internal combustion engine, hybrid proportion and zero emission proportion is indicated in brackets in each case. At the request of the driver, the further proportions of the pie chart 10, namely, the hybrid proportion 13 and the proportion of the internal combustion engine 14, can also be broken down further in each case by what are known as subsidiary pie charts, so that the driver, if desired, is provided with even more information concerning what proportions make up the individual propulsion proportions in each case. For such detailed information, the driver is provided with an insight into the influences of the various modes of operation on the overall picture and can thus adapt or optimize his driving behavior accordingly, for example for the lowest possible emission. In addition to the presentation in the form of the pie chart shown here, the modes of operation can also be presented in another form, such as in the form of a bar chart or in the form of what are known as temperature curves.

FIG. 2 shows a chart in which two ordinates 21 and 24 are presented on which various vehicle variables can be plotted. The vehicle variables to be plotted therein can be selected using a drop-down menu 26, indicated by arrow 22 or 23. In this case, the abscissa 25 has various trips by the motor vehicle plotted on it, displayed as trip 1, trip 2, trip 3 and trip 4. Hence, two different curves 27 and 28 are obtained, one showing a respective trip as a function of a CO₂ balance, plotted on the ordinate 24, and one showing a respective trip as a function of a proportion of electric driving, plotted on the ordinate 21. An overlap between these two curves or a presentation of these two curves in such a chart allows these vehicle variables to be related to one another too. In this case, it is clearly evident that the greater the proportion of electric driving, the lower the CO₂ balance. Such learning curves can ultimately be used to influence the driving behavior of a driver or to gain knowledge of an optimized driving behavior. As vehicle variables to be displayed on the respective ordinates 21 and 24, it is possible to select from the drop-down menu 26 an electrical consumption, for example, as an absolute value or as a value relative to the distance travelled, a fuel consumption likewise as an absolute value or as a value relative to a distance travelled, and also a CO₂ balance, a zero emission proportion, an average speed, etc.

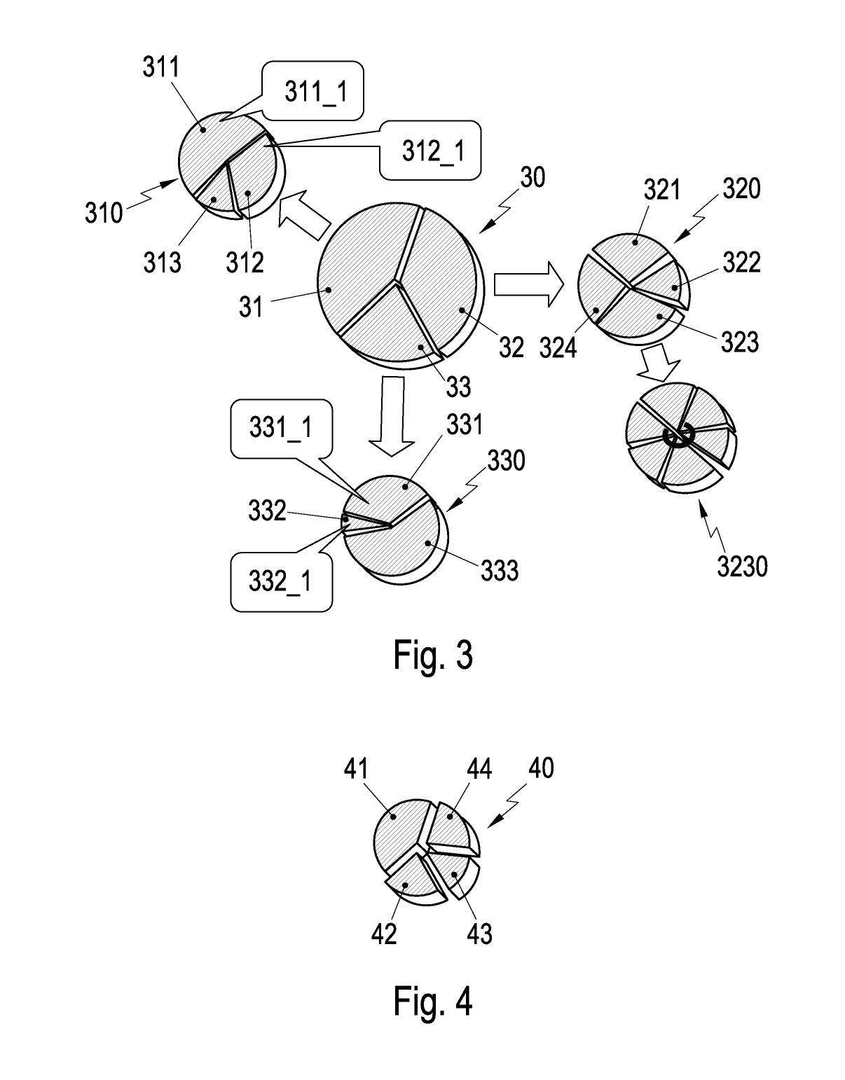

FIG. 3 shows a display in a further embodiment of a display device according to the invention. In this case, a pie chart 30 showing the proportions of the respective propulsion systems is displayed centrally on a display of the display device. In a similar manner to in FIG. 1, the pie chart is divided into three portions in this case, namely propulsion by an internal combustion engine 31, a zero emission proportion 32 and a hybrid proportion 33. The respective proportions can in turn be specified further in what are known as subsidiary pie charts. It is thus possible for the zero emission proportion 32 to be broken down further in a further pie chart 320 into a coasting mode of operation 321, a starting/stopping proportion 322, recuperation 323 and pure electric driving 324. The proportion of the hybrid propulsion 33 can be broken down further in a subsidiary pie chart 330 into a boost proportion 331, fired in a pulsion with recuperation 332 and a charge state at standstill 333. In this case, in one particular refinement, besides the pure breakdown of the various proportions for the hybrid proportion, the “blobbing on” of further information, particularly tips for the driving behavior of the driver, is displayed, based on respective displayed proportions of the pie chart 330. For the boost proportion 331, the tip 331_1 cited here by way of example is that hard acceleration processes such as kickdown should be avoided. For the proportion of fired impulsion with recuperation 332, the tip 332_1 cited is that short distances with internal combustion engines should be avoided, this occurring primarily in warm-up. These additionally provided displays represent an expert system underlying the display, which means that, automatically or at the request of the driver, it is possible to retrieve information, particularly tips regarding further driving behavior, from an expert system stored in the display device, and said information is displayed there in suitable fashion, in a particular operating state for particular proportions.

In the case of a further specific and detailed presentation of the proportion of the internal combustion engine 31, a subsidiary pie chart 310 is likewise obtained, with the greatest portion of the pie chart 310 being driving with the internal combustion engine 311. For this largest proportion 311, a tip 311_1 is again provided upon request or automatically, namely that short distances with the internal combustion engine should be avoided, which occurs primarily in warm-up or in the case of sporty driving. A further proportion is idling 312, with a tip 312_1 being able to be output by the expert system in this case too. A further proportion 313 is fired impulsion.

In the display presented here, the mode of operation is broken down into very fine detail, first of all in a pie chart 30, the proportions of which are further broken down into subsidiary pie charts 310, 320 and 330. In addition, for various proportions, a stored expert system is used to provide the driver with information, particularly tips, which, if followed, can optimize his driving behavior and hence possibly the operating state of the motor vehicle. As shown for the pie chart 320 in this case, the respective pieces of pie, such as the recuperation piece of pie 323 in this case, can each be split again into further subsidiary pie charts, as in this case into a further pie chart 3230.

In the same way, it is also possible for the driving resistances in a current mode of operation to be proportionally indicated, as shown schematically in FIG. 4. In this case, the driving resistances displayed may be acceleration 41, rolling 44, ascent 43 and air resistance 42. Preferably, such a split is also displayed in a pie chart 40, since in this case the driver is provided with a quick overview of the percentage proportions.

What is claimed:

1. A display device for presenting a plurality of vehicle variables for a motor vehicle, wherein the display device has a display unit for displaying the vehicle variables, a first selection module for selecting vehicle variables to be displayed, a computation unit for ascertaining the vehicle variables to be displayed and at least one interface to at least one vehicle device in the motor vehicle, wherein data for ascertaining the selected vehicle variables to be displayed can be retrieved from the at least one vehicle device via the interface, the selected vehicle variables can be ascertained by means of the computation unit and can be displayed on the display unit, wherein the selected vehicle variables can be presented in relation to one another and/or to an operating state of the motor vehicle.

2. The display device as claimed in claim 1, which has at least one interface to at least one vehicle device chosen from the group comprising engine controller, charging and discharge sensor for monitoring a charging or discharge process for a storage battery device, distance sensor and/or time sensor.

3. The display device as claimed in claim 1, in which the selection of vehicle variables to be displayed can be made from a predefined and stored selection of vehicle variables.

4. The display device as claimed in claim 1, which also has a second selection module which can be used to make a selection for one or more forms of presentation.

5. The display device as claimed in claim 4, in which the selection of forms of presentation can be made from predefined and stored selection of forms of presentation.

6. The display device as claimed in claim 5, in which the predefined and stored selection of forms of presentation comprises at least the group comprising bar chart, pie chart and temperature curve chart.

7. The display device as claimed in claim 1, in which the computation unit is also configured to evaluate the vehicle variables to be displayed prior to corresponding display, in particular to compare them with respective appropriate reference values and/or to base them on a current operating state of the motor vehicle.

8. The display device as claimed in claim 7, in which the computation unit is also configured to take a performed evaluation as a basis for creating and outputting respective learning curves for a driving behavior on the basis of various vehicle variables to be selected.

9. The display device as claimed in claim 1, the display unit of which can be used to present a plurality of presentations for the vehicle variables to be displayed optionally simultaneously and/or in suitably overlapping fashion.

10. The display device as claimed in claim 9, the display unit of which can be used to produce a display of the vehicle variables to be displayed in a tree structure, with dependencies of the vehicle variables being able to be mapped by the tree structure.

11. The display device as claimed in claim 10, in which the display of the tree structure can be optionally extended dynamically by means of appropriate activation.

12. The display device as claimed in claim 1, in which the display unit is also configured to show comments for a user of the display device in relation to vehicle variables displayed on the display unit automatically and/or upon request.

13. The display device as claimed in claim 12, in which the comments to be shown automatically and/or upon request can be retrieved from an expert system which is accessible to the display device.

14. The display device as claimed in claim 3, in which the predefined and stored selection of vehicle variables comprises at least a CO₂ balance, a zero emission proportion in a respective operating state of the motor vehicle, respective proportions of various loads present in the motor vehicle in propulsion of the motor vehicle in a respective operating state of the motor vehicle, respective proportions of the various loads in respective emissions from the motor vehicle, speed travelled, average speed.

15. The display device as claimed in claim 1, in which the first selection module is implemented in the form of a menu on a display of the display unit.

16. The display device as claimed in claim 4, in which the second selection module is implemented interactive on the display unit.

17. A method for presenting vehicle variables for a motor vehicle, wherein a display device having a display unit for displaying the vehicle variables, a first selection module for selecting vehicle variables to be displayed, a computation unit for ascertaining the vehicle variables to be displayed and at least one interface to at least one vehicle device of the motor vehicle is provided, wherein data for ascertaining the selected vehicle variables to be displayed are retrieved from the vehicle device via the interface, the selected vehicle variables are ascertained by means of the computation unit and are displayed on the display unit, wherein the selected vehicle variables are presented in relation to one another and/or to an operating state of the motor vehicle.
